(19) United States
(12) Patent Application Publication
(10) Pub. No.: US 2007/0174331 A1
(43) Pub. Date: Jul. 26, 2007

(54) SYSTEM AND METHOD FOR EXTENDING THE BUSINESS DATA ASSOCIATED WITH A NETWORK-BASED USER COLLABORATION TOOL TO INCLUDE SPATIAL REFERENCE INFORMATION FOR COLLABORATIVE VISUALIZATION

(76) Inventors: Robert P. Wolf, O'Fallon, MO (US); Mark A. Seward, St. Louis, MO (US); Robert D. MacMorran, O'Fallon, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/620,478

(22) Filed: Jan. 5, 2007

Related U.S. Application Data
(60) Provisional application No. 60/756,827, filed on Jan. 6, 2006.

(51) Int. Cl. G06F 7/00

(52) U.S. Cl. 707/102

(57) ABSTRACT

Systems and methods consistent with the present invention provide a data processing system for extending the business data associated with a collaboration tool engine to include spatial reference information for collaborative visualization. The engine has business data type schemas for generating an information store container associated with a respective business data element. A control specification having an information store type schema identifying a corresponding spatial data type schema is provided to the engine. In response to a request, a new information store is generated based on the business type schemas. A roster identifying the information store type schema is provided to the requester. In response to another request, the data processing system generates, via the collaboration tool engine, a spatial reference point container in the new information store for the information store type schema based on the spatial data type schema identified by the information store type schema.

### CROSS-REFERENCE TO RELATED APPLICATIONS

This application claims the benefit of the filing date of U.S. Provisional Application No. 60/756,827, entitled “A System and Method for Extending the Business Data Associated with a Network Based User Collaboration Tool to Include Spatial Reference Information for Collaborative Mapping,” filed on Jan. 6, 2006, which is incorporated herein by reference to the extent permitted by law.

### FIELD OF THE INVENTION

The invention relates generally to network-based collaboration tools, and more particularly to systems and methods for enabling a collaboration tool to generate and map or otherwise visualize geographically referenced information.

### BACKGROUND OF THE INVENTION

Standard network-based user collaboration tools, such as Microsoft's SharePoint®, allow users to collaboratively generate, store, and display business data or information (e.g. SharePoint® lists, images, forms, and documents), associated with a defined project or business data model. However, SharePoint currently lacks the ability to allow users to associate geographical references with the collaboratively generated business data and therefore lacks the ability to map or three dimensionally visualize the geographical references so that users can graphically view newly generated, modified, or removed geographical references associated with the given business data model.

Therefore, a need exists for systems and methods that overcome the problems noted above and others previously experienced for extending the business data associated with a network-based user collaboration tool to include spatial reference information for collaborative mapping and visualization.

### SUMMARY OF THE INVENTION

Systems and methods consistent with the present invention extend the capabilities of a network-based user collaboration tool to associate spatial reference information with business data stored in information stores associated with the collaboration tool. The term “information store” as used herein is intended to encompass any mechanism provided by a particular collaboration tool for storage of, or direct or indirect access to, business data irrespective of the collaboration tool's vendor-specific terminology or underlying method(s) of technical realization. In particular, a system and method consistent with the present invention extends Microsoft® SharePoint® stored list, image, form, and document data to be geographically aware. The method operates such that street addresses in SharePoint® information stores are automatically converted to the corresponding latitude & longitude in near-real time without user interaction.

Systems consistent with the present invention also provide a web-based geographical information system (“GIS”) viewer application which merges conventional GIS infrastructure layers, viewing controls, and mapping and visualization techniques with such SharePoint®—stored data, including dynamic discovery of all GIS-enabled data within a SharePoint installation. Hereafter the term “visualization” will refer to a computerized rendering of two-dimensional maps, aerial photograph overlays, and mosaics as well as three-dimensional images, photographs, montages, fly-throughs, “bird's eye views”, and other known three-dimensional images.

In addition, integrated linkages between the collaboration tool (e.g. SharePoint®) and the viewer web application are provided in systems consistent with the present invention such that users can switch at will between viewing data points in either the collaboration tool's business data display or the web-based GIS viewer web application.

In accordance with methods consistent with the present invention, a method in a data processing system for extending the business data associated with a network-based user collaboration tool engine to include spatial reference information for collaborative visualization is provided. The collaboration tool engine has one or more business data type schemas for generating an information store container associated with a respective business data element. The method comprises providing a control specification to the collaboration tool engine. The control specification has one or more information store type schemas. Each information store type schema identifies a corresponding spatial data type schema in association with a geographical data type schema. The method further comprises receiving a request to generate a new information store; generating, via the collaboration tool engine, the new information store based on the one or more business type schemas; providing to the requester a roster identifying the one or more information store type schemas; receiving a second request to add the one or more information store type schemas to the new information store; and in response to the second request, generating, via the collaboration tool engine, a spatial reference point container in the new information store for each of the one or more information store type schemas based on the spatial data type schema identified by the respective information store type schema.

In accordance with systems consistent with the present invention, a data processing system is provided. The data processing system comprises a collaboration tool system that includes a secondary storage having a control specification. The control specification has one or more information store type schemas. Each information store type schema identifies a corresponding spatial data type schema in association with a geographical data type schema. The collaboration tool system further includes a memory having a collaboration tool server and a geo-code driver operatively connected to the collaboration tool server and operatively configured to communicate with a geo-coding source. The collaboration tool server is operatively configured to control a collaboration tool engine based on the control specification, receive a request to generate a new information store, generate the new information store based on the one or more business type schemas via the collaboration tool engine, provide to the requester a roster identifying the one or more information store type schemas, receive a second request to add the one or more information store type schemas to the new information store, and, in response to the second request, generate a spatial reference point container in the new information store for each of the one or more information store type schemas based on the spatial data type schema identified by the respective information store type schema. The collaboration tool system further includes a processor to run the collaboration tool server and the geo-code driver.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1A is a block diagram of a data processing system having a collaboration tool system enabled in accordance with the present invention to generate, store, and display geographical reference points associated with business data generated by or accessible through the collaboration tool system;

FIG. 1B is an exemplary functional block diagram of the data processing system of FIG. 1A;

FIG. 2 depicts an exemplary control specification file received by the collaboration tool system to define user accessible information stores in accordance with the present invention;

FIG. 3 depicts a flow diagram illustrating a process performed by a collaboration tool server in the collaboration tool system to allow a user to generate a GIS-enabled information store consistent with the present invention;

FIG. 4 depicts a flow diagram illustrating a process performed by the collaboration tool server to allow a user to create and update a record in a GIS-enabled information store in accordance with the present invention; and

FIG. 5 depicts a flow diagram illustrating a process performed by the collaboration tool server and the web-based GIS viewer to allow user to selectively view a visualization of one or more GIS-enabled information stores in accordance with the present invention.

### DETAILED DESCRIPTION OF THE INVENTION

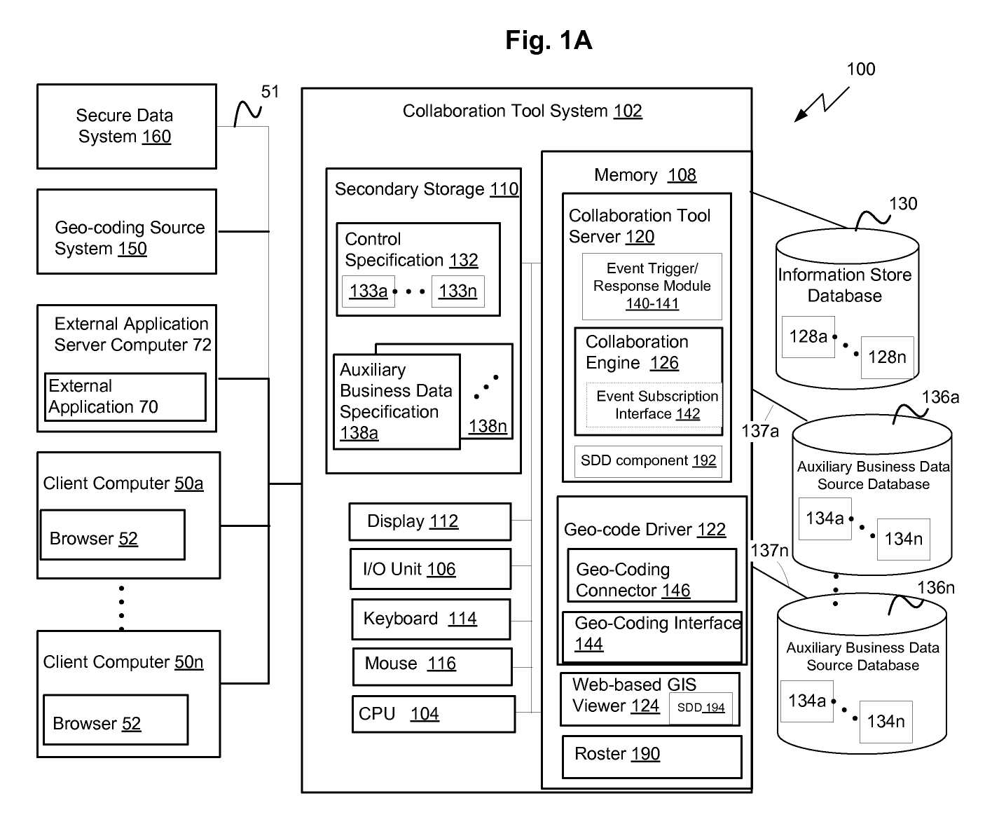

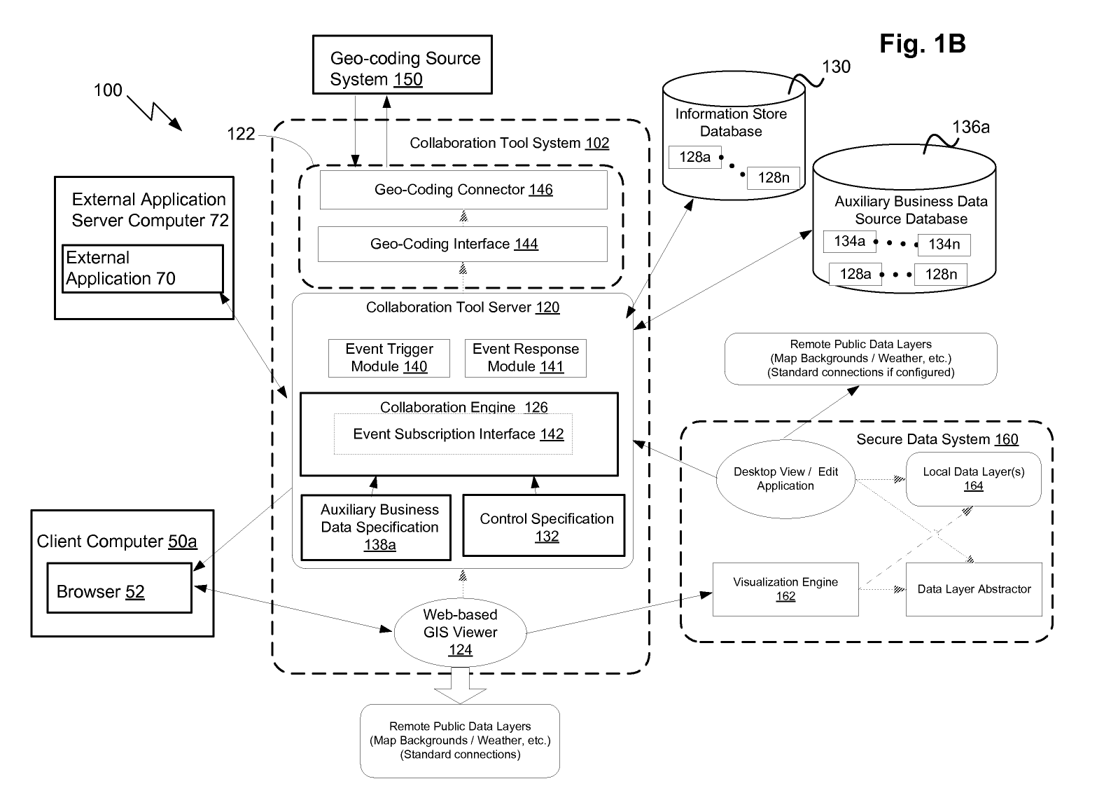

FIG. 1A is a block diagram of a data processing system 100 having a collaboration tool system 102 enabled in accordance with the present invention to generate, store, and display geographical reference points associated with business data generated or accessed by or accessible through the collaboration tool system. FIG. 1B is an exemplary functional block diagram of the image processing system 100 of FIG. 1A. The data processing system 100 includes one or more client computers 50a-50n that are operatively connected via a network 51 to the collaboration tool system 102. The client computers 50a-50n may be any general-purpose computer system such as an IBM compatible, Apple, or other equivalent computer. The network 51 may be any known private or public communication network, such as a local area network (“LAN”), WAN, Peer-to-Peer, or the Internet, using standard communications protocols. The network 51 may include hardwired, as well as wireless branches.

As shown in FIG. 1, the collaboration tool system 102 comprises a central processing unit (CPU) 104, an input output (I/O) unit 106 for communicating across the network 51, a memory 108, a secondary storage device 110, and a display 112. The collaboration tool system 102 may further comprise standard input devices such as a keyboard 114, a mouse 116 or a speech processing means (not illustrated). The various components of the collaboration tool system 102 may be physically located remotely from each other and connected via the network 51.

Memory 108 stores a collaboration tool server 120, a geo-code driver 122, and web-based GIS viewer 124. As discussed in detail below, the collaboration tool server 120 encapsulates or extends the capabilities of an existing collaboration engine 126 to enable one or more users operating client computers 50 to create, access, and modify an information store 128a-128n so that spatial reference information and corresponding geographical reference point are associated with business data in the information store 128a-128n.

In one implementation, the collaboration tool system 102 may be operatively connected to a database 130 for storing information stores 128a-128n generated by the collaboration tool server 120 as further described herein. However, the information stores 128a-128n may be contained in memory 108, secondary storage 110, or in a remote storage (not shown in figures) across the network 51.

The collaboration tool system 102 implemented in accordance with the present invention is referenced herein as a GIS-Enabled SharePoint® system. However, the present invention may be employed using other known collaboration tools such as Oracle Collaboration Suite or IBM Lotus Notes/Domino.

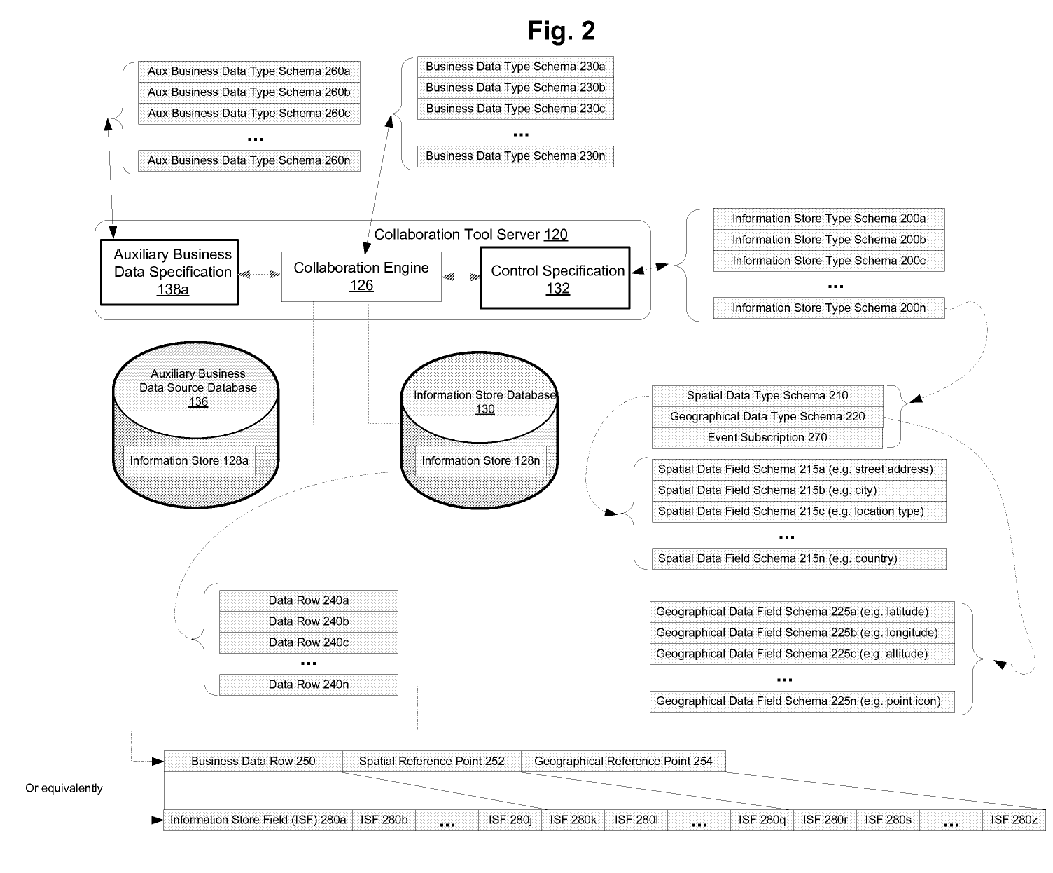

As shown in FIG. 1, the data processing system 100 also includes a control file or specification 132. The term “specification” is used herein to generically refer to a persistent storage facility, interface, and content format operatively configured in accordance with the existing collaboration tool engine 126. Each control specification 132 serves to define and control the GIS-specific extensions (e.g., geographical reference point 254 in FIG. 2) to the collaboration tool engine 126's information stores 128a-128n. The control specification 132 has one or more information store definitions 133a-133n each of which identifies a corresponding business data element type (e.g., city emergency response entity, such as a fire department) in association with a spatial reference point type (e.g., street address). For example, as shown in FIG. 2, each information store definition 133a-133n of the control specification 132 may correspond to a respective information store type schema 200a-200n having a structure consistent with data types recognizable by the collaboration tool engine 126 such that the collaboration tool engine may be prompted to instantiate or form an information store 128a-128n in accordance with a request from a user accessing the collaboration tool server 120. In the implementation shown in FIG. 2, the control specification 132 has one or more information store type schemas 200a-200n, each of which defines the schema for a particular type of information store 128a-128n. Each information store type schema 200a-200n includes two sub-schemas, a spatial data type schema 210 and a geographical data type schema 220. The spatial data type schema 210 includes one or more spatial data field schemas 215a-215n which define the attributes (data type, storage size, etc) of specific spatial data fields, such as street address, postal code, country, or other spatial reference information. The geographical data type schema 220 includes one or more geographical data field schemas 225a-225n which define the attributes (data type, storage size, etc) of the specific geographical data fields, such as latitude, longitude, point type, display icon, or other geographical reference information.

The collaboration tool engine 126 includes a plurality of business data type schemas 230a-230n. The collaboration tool server 120 is operatively configured to recognize and selectively cause the collaboration tool engine 126 to instantiate each business data type schema 230a-230n as a business data element container or row 250 in an information store 128a-128n based on a user or application 70 request as described in further detail herein. The content and structure of business data type schemas 230a-230n is based on the vendor and version of the collaboration engine 126. The business data type schemas 230a-230n may be hierarchical and/or extendable. In one implementation, the structure and format of information store type schemas 200a-200n and business data type schemas 230a-230n are substantially the same.

The collaboration tool server's 120 collaboration tool engine 126 processes the control specification 132 in conjunction with the business data store schemas 230a-230n provided during the installation of the collaboration tool server 120 or by the end user operating the client computer 50 to construct or extend GIS-enabled information stores 128a-128n in accordance with the control specification 132 as further discussed below. Thus, the collaboration tool server 120 effectively enables user selectable business data schema(s) (e.g., 230n in FIG. 2), the spatial schema (e.g., 210) and the geographical schema (e.g., 220) into a single GIS-enabled schema from which a respective information store (e.g., 128n in FIG. 2) may be instantiated by the collaboration tool server 120 via the collaboration tool engine 126. As shown in FIG. 2, when the collaboration tool server 120 causes the information store 128n to be instantiated, the information store 128n includes one or more data rows 240a-240n. Each data row 240a-240n includes a business data portion 250 corresponding to the selected business data type schema(s) 230a-230n, spatial reference point portion(s) 252 corresponding to the selected spatial data type schema(s) 210, and geographical reference point portion(s) 254 corresponding to the selected geographical data type schema(s) 220.

In one implementation in which the collaboration tool engine 126 corresponds to GIS-Enabled SharePoint® 2003, the control specification 132 comprises one or more SharePoint® List Templates, which may be used to implement one or more information store type schemas 200a-200n. SharePoint® List Templates are physically implemented as XML data files stored on the SharePoint server(s) whose content format is conventional XML and SharePoint's proprietary dialect thereof (i.e., Collaborative Application Markup Language (CAML)). These files are physically stored on the machine(s) hosting the collaboration engine 126. In this implementation, several varieties of SharePoint® List Templates may be provided to support and extend the various built-in business data type schemas of the GIS-Enabled SharePoint® 2003 collaboration tool engine 126. The List Templates employed by the collaboration tool server 120 for the control specification 132 enable the collaboration tool server 120 to prompt the collaboration tool engine 126 to generate a combined information store schema based on user selected information store type schema 200a-200n and user selected business fields corresponding to the business data type schema(s) 230a-230n as discussed above. Implementation details for List Templates are available from Microsoft at http://msdn2.microsoft.com/en-us/library/ms980852.aspx and http://msdn2.microsoft.com/en-us/library/ms983903.aspx

In another implementation in which the collaboration tool engine 126 corresponds to GIS-Enabled SharePoint® 2007, the control specification comprises one or more SharePoint® List Templates and also SharePoint Content Type Definition Features, which collectively may be used to implement one or more information store type schemas 200a-200n as discussed herein. The SharePoint® List Templates and SharePoint Content Type Definition Features are physically implemented as XML data files whose content format is conventional XML and SharePoint's proprietary dialect (i.e., CAML). These files are physically stored on the machine(s) hosting the collaboration engine 126. Implementation details for SharePoint Content Type Definition Features are available from Microsoft at http://msdn2.microsoft.com/en-us/library/ms434313.aspx http://msdn2.microsoft.com/en-us/library/ms460318.aspx

The collaboration tool engine 126 may, depending on the specific brand, model, version, and configuration of the collaboration tool engine 126, provide access to auxiliary business data elements 134a-134n stored, for example, in a database 136 associated with a particular business data source of an enterprise or company. Without limitation, examples of auxiliary business data elements 134a-134n include enterprise customer relationship management (“CRM”) systems, employee data (Human Relations) systems, government agency caseload management systems, hospital medical records systems, and other known business data elements. The database 136 may be accessible by the collaboration tool server 120 across the network 51 or via a local or a respective private network 137a-137n. When operatively configured via auxiliary business data specifications 138a-138n, such data is made accessible to users of the collaboration tool engine 126 and hence users of the collaboration tool system 102, in a manner which largely or completely mimics that of information actually stored within the collaboration tool engine 126. The collaboration tool engine 126 may use any technical means to catalog, retrieve, display, and update such auxiliary business data that may itself reside in any storage or access technology interoperable with the collaboration tool engine 126.

The format and structure of an auxiliary business data specifications 138a-138n is based on the specific vendor and version of the collaboration tool engine 126. Typically an auxiliary business data specification 138 will include information elements describing the technical method of communication (e.g., direct SQL database connection, XML web service, RPC, or other communication technique.), the location of the source server (e.g. address, DNS name, server name, database identity, or other source server location information); the security protocol and security identity (e.g., type of authentication, user logon, user password or certificate, encryption requirements and protocols); the specific data elements to retrieve or update (e.g. named XML service methods, SQL tables, views, stored procedures, etc. and their corresponding input parameter requirements and result set schemas, such as field names, data types, data sizes, and data relationships), any translation between the data types and schemas supported by the source and that supported by the collaboration tool engine 126. Additional similarly-structured elements may provide information required for the collaboration engine 126 to perform updates to the auxiliary business data elements 134a-134n.

When auxiliary business data elements 134a-134n are available or stored on an auxiliary business data source database 136a-136n and configured for access by the collaboration tool server 120 via a respective auxiliary business data source specification (e.g., 138a in FIG. 2 ) that includes auxiliary business data type schemas 260a-260n, the collaboration tool server 120 processes the auxiliary business data source specification 138a to effectively cause the collaboration tool engine 126 to generate an information store (e.g., information store 128a) substantially equivalent to an information store (e.g., information store 128n) generated by the collaboration tool engine 126 using the control specification 132 as discussed above. Thus, in accordance with the present invention, the collaboration tool server 120 is operatively configured to extend the capabilities of the collaboration tool engine 126 so that the collaboration tool engine 126 is equally capable of operating on auxiliary business data 134a-134n. Accordingly, an information store 128a-128n, as used throughout, may include information stores generated based on auxiliary business data and information stores generated based on business data associated with the information store definitions 133a-133n or information store type schemas 200a-200n in the control specification 132.

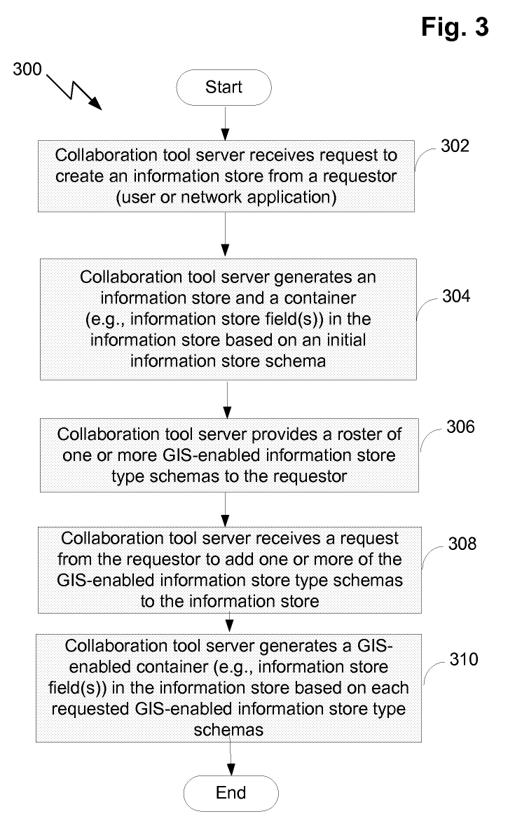

A user, via a browser 52 on a client computer 50, may access the collaboration tool server 120 to create, edit or delete information stores 128a-128n (e.g. SharePoint® lists, libraries, etc.) hosted on the collaboration tool server 120, and to attach or detach GIS-enablement to them as described in further detail below, for example, in reference to FIG. 3. After processing the control specification 132, the collaboration tool server 120 effectively causes the collaboration tool engine 126 to be operatively configured to expose a new or amended GIS-Enabled information store 128a-128n in accordance with a respective information store definition 133a-133n in the control specification 132. As shown in FIG. 2, each information store 128a-128n functions as a container for data rows 140a-140n, each of which has capacity for storing both arbitrary business data 250, a corresponding spatial reference point 250 and a geographical reference point 254. Each information store 128a-128n generated by or accessible by the collaboration tool server 120 via the collaboration tool engine 126 immediately becomes accessible to the geo-coding driver 122 and the web-based GIS viewer 124.

An external application 70, of whatever description(s) or purpose(s), running on external application server 72 may access the collaboration tool server 120 to create, edit or delete information stores 128a-128n (e.g. SharePoint® lists, libraries, etc.) hosted on the collaboration tool server 120, and to attach or detach GIS-enablement to them as described in further detail below, for example, in reference to FIG. 3. After processing the control specification 132, the collaboration tool server 120 effectively causes the collaboration tool engine 126 to be operatively configured to expose a new or amended GIS-Enabled information store 128a-128n in accordance with a respective information store definition 133a-133n in the control specification 132. As shown in FIG. 2, each information store 128a-128n functions as a container for data rows 140a-140n, each of which has capacity for storing both arbitrary business data 250, a corresponding spatial reference point 250 and a geographical reference point 254. Each information store 128a-128n generated by or accessible by the collaboration tool server 120 via the collaboration tool engine 126 immediately becomes accessible to the geo-coding driver 122 and the web-based GIS viewer 124.

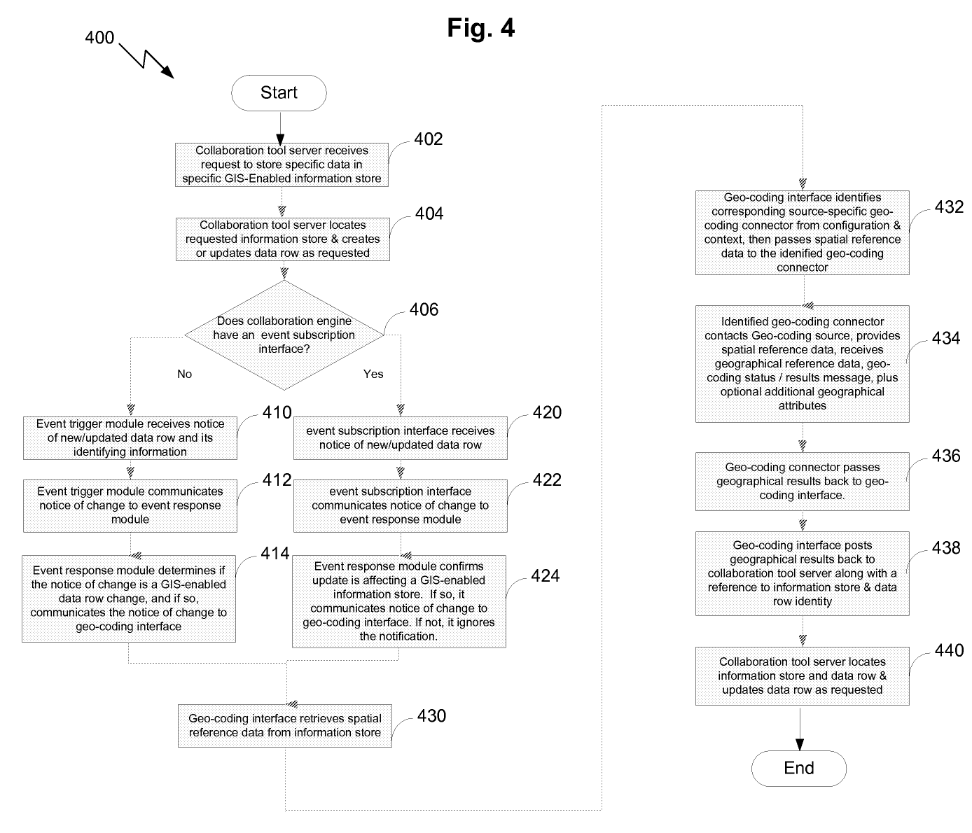

One of ordinary skill in the art will appreciate that the access technique implemented by the collaboration tool server 120 and the external application 70 may vary depending on the particular collaboration tool engine 126 employed by the collaboration tool server 120. For example, when the collaboration tool engine 126 employed by the collaboration tool server 120 is SharePoint® and extended or encapsulated in accordance with the present invention, an external application 70 may use an XML web service and/or a remote procedure call (RPC) technique to communicate with the collaboration tool server 120. A user, via a browser 52 (such as Internet Explorer® or Netscape®) on a client computer system 50, may access the collaboration tool server 120 to create and/or edit a GIS-enabled data row 240 associated with GIS-enabled information store 128a-128n (e.g. save, edit, & delete SharePoint®-stored list items, forms, and documents) hosted on the collaboration tool server 120 as further described herein, for example, in reference to FIG. 4.

An external application 70, of whatever description(s) or purpose(s), running on external application server 72 may access the collaboration tool server 120 via the network 51 to create and/or edit GIS-enabled data containers or rows 240 associated with GIS-enabled information store 128a-128n (e.g. save, edit, & delete SharePoint®-stored list items, forms, and documents) hosted on the collaboration tool server 120. One of ordinary skill in the art will appreciate that the access technique implemented by the collaboration tool server 120 and the external application 70 may vary depending on the particular collaboration tool engine 126 employed by the collaboration tool server 120. For example, when the collaboration tool engine 126 employed by the collaboration tool server 120 is SharePoint® and extended or encapsulated in accordance with the present invention, an external application 70 may use an XML web service and/or a remote procedure call (RPC) technique to communicate with the collaboration tool server 120. In addition, an external application 70 may mine external data sources for items of interest or gather data from other line-of-business applications (not shown in figures) and use the collaboration tool system 102 as a publishing or distribution channel or as an archive by generating GIS-enabled information stores 128a-128n via the collaboration tool server 120.

As shown in FIGS. 1A and 1B, the collaboration tool server 120 also includes one or more event trigger/response components or modules 140 (e.g., GIS-Enabled SharePoint® Event Triggers or Features) each of which monitors a predetermined location or collection of information store 128a-128n locations, such as a SharePoint® data store location, where respective GIS-enabled information stores 128a-128n may have been created and stored by the collaboration tool server 120. Each of the event trigger/response modules 140 is operatively configured to react to or generate an event trigger upon the creation or deletion of GIS-enabled information stores 128a-128n, the creation or deletion of GIS-enabled records/documents within each of the information stores 128a-128n (e.g., business data row 250 information), and the update of GIS-significant fields (e.g., spatial reference point 252 or geographical reference point 254) within or associated with such records/documents. The event trigger mechanism of the event-trigger modules may be implemented across any technology base associated with the collaboration tool engine 126 encapsulated or implemented in the collaboration tool server 120. In one implementation in which the collaboration tool engine 126 is Microsoft® SharePoint,® the collaboration tool server 120 may utilize several Microsoft® technologies to implement the event trigger mechanism of the event trigger/response modules 140, including but not limited to SQL Server, MSMQ, .NET XML web services, and the SharePoint® object model and SharePoint® event facility.

The conversion of a street address, street intersection, or similar culturally-described location (i.e. “a spatial reference point”) to a latitude/longitude pair (i.e. a “geographical reference point” or “X/Y pair”) is conventionally termed “geo-coding”. Geo-coding can be performed by any number of publicly accessible geo-coding vendors such as ESRI, Google Maps®, or Microsoft® Virtual Earth®, as well as by privately-owned & locally installed specialist software from a similar array of vendors. Collectively these facilities are referred to herein as “geo-coding sources” or “geo-coding source systems”. Particular geo-coding source systems may also return additional geographic information such as altitude; perform additional geographic services such as address correction; provide auxiliary cultural information, and other geographic related information. In each case data returned is applicable to the particular X/Y coordinate.

The geo-code driver 122 includes a source-agnostic geo-coding interface 144 and a plurality of source-specific geo-coding connectors 146. The geo-coding interface 144 is operatively configured to receive an event triggered by a respective event trigger/response module 140 of the collaboration tool server 120 and transfer the event to a corresponding one of the geo-coding connectors 146. Each geo-coding connector 146 is operatively configured to communicate with a respective geo-coding source system 150 using one of a variety of mechanisms, such as an XML web service, an RPC, or SQL record or file system drop. Regardless of the mechanisms used, in response to receiving an event from a respective event trigger/response module 140 via the geo-coding interface 144, each geo-coding connector 146 provides to the respective geo-coding source system 150 an address derived from the GIS-enabled information store 128a or 128n having the newly created or changed GIS-significant field (e.g., new or modified spatial reference point 252). In return, the respective geo-coding connector 146 is operatively configured to receive from the respective geo-coding source system 150 a geographic reference point (e.g., a latitude and a longitude, plus other source-specific optional geographic attributes) corresponding to the spatial reference point associated with the GIS-enabled information store record or document having the newly created or changed GIS-significant field. The respective geo-coding connector 146 is adapted to post or store, via the source agnostic geo-coding interface 144, the geographic reference point 254 data in association with the GIS-enabled information store 128a or 128n record or document which caused the event to be triggered.

In one implementation, for example when the collaboration tool server 120 extends or encapsulates SharePoint® 2003 as the collaboration tool engine 126 consistent with the present, the event trigger/response module 140 is operatively configured to monitor for the collaboration tool engine 126 to update (e.g., read from or to write to) or to delete the spatial reference point 252 or the geographical reference point 254 associated with a respective information store 128a-128n. When the information store 128a-128n is updated by the collaboration tool engine 126, the event trigger module/response module 150 communicates to a geo-coding interface 144 of the geo-coding driver 122 as further described below so that the corresponding geographical reference point 254 associated with a respective information store 128a-128n may be updated to reflect any change to the spatial reference point 252 of the information store 128a-128n.

In another implementation, for example when the collaboration tool server 120 extends or encapsulates SharePoint® 2007 as the collaboration tool engine 126 consistent with the present invention, the event trigger/response module 140, the collaboration tool engine 126 includes an event subscription interface 142. In this implementation, the control specification 132 may include an event subscription 270 associated with an information store type schema (e.g., 200n) as shown in FIG. 2. The event subscription 270 causes the collaboration tool engine 126 to assign an event within the event subscription interface 142 to the event trigger/response module 140 so that when an information store (e.g., 128n) corresponding to the information store type schema (e.g., 200n) and the event subscription 270 is updated by the collaboration tool engine 126, the event subscription interface 142 communicates to the respective update event to the event trigger/response module 150. In response, the event trigger/response module 150 communicates the update event to the geo-coding interface 144 as further described below so that the corresponding geographical reference point 254 associated with a respective information store 128a-128n may be updated to reflect any change to the spatial reference point 252 of the information store 128a-128n.

In accordance with the present invention, a user, via the browser 52 on the client computer system 50, may also access the web-based GIS viewer 124 to view and/or manipulate a visualization of GIS-enabled data (e.g., spatial reference point 252 or geographical reference point 254) associated with GIS-enabled information stores 128a-128n created and managed by the collaboration tool server 120. The web-based GIS viewer 124 includes a display/control application, which may be an extension to a conventional web-based GIS viewer/editor application or toolkit, such as a web-based GIS viewer/editor commercially available from ESRI, Google®, or Microsoft®. In addition to offering the pan, zoom, search, select, and view options of a typical GIS viewer/editor, the web-based GIS viewer 124 has at least the following two key user selectable extensions: secure dynamic discovery (“SDD” interface 194 to SDD component of the collaboration tool server 120) and secure point retrieval (“SPR”) sub-process.

A conventional GIS viewer/editor requires extensive behind-the-scenes configuration to indicate exactly what data stored where in what format in the corresponding conventional GIS infrastructure will be made available for inclusion on the visualization to be viewed or exported. Each data source or list is commonly termed a “layer” for the visualization. Compared to a typical GIS infrastructure, a SharePoint® (or other collaboration tool engine) installation is very dynamic allowing a user operating the corresponding collaboration tool server 120 to create or destroy sections within the collective structure of sites distributed across a network (e.g., such as private networks 137a-137n) where information stores are located to accomplish business purpose or goal or to create or destroy the information stores themselves. These changes in structure as well as content are generally uncoordinated with the administrative personnel charged with technical stewardship of the data processing system 100. The SDD extension or component 192 of the collaboration tool server 120 is operatively configured to ensure that GIS-enabled data (e.g., spatial reference points 252 and corresponding geographic reference points 254) associated with the GIS-enabled information stores 128a-128n managed or hosted by the collaboration tool server 120 is automatically available for view immediately after the respective GIS-enabled data is created. The SDD (192 and 194 collectively) is operatively configured to vet user requested data against the security model (not shown in figures) supported by the collaboration tool server's 120 collaboration tool engine 126 (e.g., SharePoint's® security model and, indirectly, its authentication provider and role provider, such as Microsoft® Active Directory) to ensure that the given user has access to each data layer. Different users viewing the same application URL associated with one or more GIS-enabled information stores hosted on the collaboration tool server 120 may see different data layers in a visualization generated by the web-based GIS viewer 124 depending on the personal security authority or profile (not shown in figures) associated with the user. SDD communication may be accomplished via an XML web service. In one implementation, the SDD interface 194 of the web-based GIS viewer is further augmented with a manual configuration of a persistent SharePoint®-based layer to provide specific repeatable graphic symbology and/or detailed data point categorization within the layer. Absent manual configuration, the SDD assigns unique symbology to each layer.

SPR extension of the collaboration tool server 120 is operatively configured to allow the web-based GIS viewer 124 to retrieve points (e.g., geographic reference points 254 and business data attributes stored in the associated business data rows 250 of respective information stores 128a-128n) stored within the collaboration tool server's 120 installation site or within the data processing system 100. The web-based GIS viewer 124 is operatively configured to then display the retrieved points and associated business attributes in situ on the visualization web page provided to the browser 52 of the client computer 50 operated by the user. The GIS viewer 124 is also operatively configured to provide user interface (UI) linkages back into the associated GIS-enabled information store record hosted by the collaboration tool server 120. The UI linkages connect the user's browser 52 directly to the source data.

SPR communication may be implemented via an XML web service, RPC, or other typical inter-computer communications protocol/mechanism. As with SDD, retrieval of point data and construction of UI back link(s) to the point data is security-trimmed based on the personal security authority or profile associated with the user and the security granularity provided by the host collaboration tool engine 126. In one implementation, SPR is implemented via XML web service for point retrieval and client-side JavaScript for the UI linkages to the source data, while security granularity extends to the level of individual records/ entries in each GIS-Enabled information store.

In one implementation, the web-based GIS viewer 124 is operatively configured to communicate with a secure data system 160, such as a computer system located behind a firewall, having a visualization engine 162 and a plurality of local data layers 64 accessible by the visualization engine 162. The web-based GIS viewer 124 may associate one or more of the local data layers 164 with one or more data layers corresponding to GIS-enabled information stores 128a-128n managed by or hosted on the collaboration tool server 120, such that a user accessing the web-based GIS viewer 124 via the browser 52 may view a visualization of the one or more local data layers 164 overlaid with one or more data layers corresponding to the GIS-enabled information store hosted on the collaboration tool server 120.

In one implementation, the collaboration tool server 120 incorporates an extract-and-save capability. This capability permits users to identify points on a visualization generated from local data layers 164 & GIS-enabled information stores hosted on the collaboration tool server 120; and to copy such identified points into alternative existing or newly created GIS-enabled information stores hosted on the collaboration tool server 120.

Turning to FIG. 3, a flow diagram is shown illustrating a process 300 performed by the collaboration tool server 120 to allow a user to generate a GIS-enabled information store 128a-128n having the capacity to store business data rows 250 coupled with a spatial reference points 252 and corresponding geographical reference points 254 consistent with the present invention. Initially, the collaboration tool server receives a request to create an information store from a requestor (e.g., a user operating client computer 50 or a network external application 70) (step 302). In one implementation, this request takes the form of the browser 52 posting a web page (not shown in figures) to the collaboration tool server 120 providing the location and name for the desired information store 128a or 128n as well as an initial information store schema from among the business data type schemas 230a-230n and the information store type schemas 200a-200n, which includes GIS-enabled information store type schemas characterized by or having spatial data type schema 210 and a corresponding geographical data type schema 220. In an alternate implementation, the request takes the form of an XML web service call (not shown in the figures) from an external application 70 to the collaboration tool server 120 providing the location and name for the desired information store 128a or 128n as well as the desired initial information store schema from among the business data type schemas 230a-230n and the information store type schemas 200a-200n, which includes GIS-enabled information store type schemas characterized by or having spatial data type schema 210 and a corresponding geographical data type schema 220. One of ordinary skill in the art will appreciate that additional or differing means of accomplishing the logically equivalent outcome may exist using various collaboration engines 126 and the collaboration tool server 120.

The collaboration tool server 120 then generates an information store (e.g. 128a) and a container (e.g., information store field 280a-280n) in the information store (e.g., 128a) based on an initial information store type schema (step 304), for example, as identified to the server 120 as part of the request received in step 302. In one implementation, the collaboration tool server 120 prompts the collaboration engine 126 (using known input techniques associated with the engine 126 such as SharePoint® List Templates) to access the initial information store type schema and make corresponding entries in the information store database 130 to record a new instance of an information store (e.g. 128a). In addition, in a similar manner the collaboration tool server 120 causes the engine 126 to make entries in the information store database 130 to implement the information store fields 280a-280n specified by the chosen initial information store type schema by recording their attributes (e.g. name, data type, storage capacity, display format, etc) and additional other information store attributes as there may exist in the initial information store type schema (e.g. display options or security restrictions). Accordingly, entries are made in the information store database 130 to add initial data row(s) 240a-240n to the newly created information store (e.g. 128a) based on the chosen initial information store type schema.

Next, the collaboration tool server 120 provides a roster 190 in FIG. 1A of one or more GIS-enabled information store type schemas to the requestor (step 306). In one implementation, the collaboration tool server 120 responds to the web page post of step 302 by replying with a web page (not shown in figures) indicating success in the creation of the information store 128a and showing the initial information store schema associated with the information store 128a. In addition, the web page may include a display of additional available business data type schemas 230a-230n and information store type schemas 200a-200n, including GIS-Enabled information store type schemas having spatial data type schema 210 and a corresponding geographical data type schema 220 derived from the control specification 132. Upon receipt of the display of such schemas, the user may elect to cause his browser 50 to request that the collaboration tool server 120 add a plurality of such schemas, including GIS-enabled information store type schemas, to the schema of the instant information store (e.g. 128a). In an alternate implementation in which the requester is an external application 70, the roster 190 may be provided in the form of an XML web service response back to the external application 70 from the collaboration tool server 120 indicating success in the creation of the information store and showing the initial information store schema associated with the information store 128a. Additional XML web services and web service methods may be used by the collaboration tool server 120 to make available to the external application 70 (on request) an enumeration of the available business data type schemas 230a-230n. and the information store type schemas 200a-200n, including GIS-Enabled information store type schemas derived from control specification 132. Upon receipt of the enumeration of such schemas, the external application 70 may elect to request that the collaboration tool server 120 add a plurality of such schemas, including GIS-Enabled schemas, to the schema associated with the instant information store (e.g. 128a). One of ordinary skill in the art will appreciate that additional or differing means of accomplishing the logically equivalent outcome may exist using various collaboration engines 126 and the collaboration tool server 120.

Next, the collaboration tool server 120 receives a request from the requestor to add one or more of the GIS-enabled information store schemas to the information store (step 308). In one implementation, this request takes the form of the browser 52 posting a web page (not shown in figures) to the collaboration tool server 120 providing the identity of the information store 128a as well as the identity(ies) of a plurality of desired additional information store schema(s) from among the business data type schemas 230a-230n. and the information store type schemas 200a-200n, including GIS-enabled information store type schemas having a respective spatial data type schema 210 and a corresponding geographical data type schema 220. In an alternate implementation the request takes the form of an XML web service call from an external application 70 to the collaboration tool server 120 providing the identity of the information store 128a as well as the identity(ies) of a plurality of desired additional information store schema(s) from among the business data type schemas 230a-230n. and the information store type schemas 200a-200n, including GIS-enabled information store type schemas having a respective spatial data type schema 210 and a corresponding geographical data type schema 220. One ordinarily skilled in the art can readily appreciate that other communication techniques for receiving a request from a user or an external application other than a web page or an XML web service call may be employed without departing from the scope of the present invention.

The collaboration tool server 120 then generates a container (e.g., information store field 280a-280n) in the information store based on each requested GIS-enabled information store schema (step 310) before ending processing. In one implementation, the collaboration tool server 120 causes the collaboration engine 126 to locate the schema (e.g., business data type schemas 230a-230n and/or information store type schemas 200a-200n) associated with the referenced information store (e.g. 128a) from its information store database 130, and for each requested GIS-enabled information store schema, access the requested schema (e.g., 200n) from the control specification 132 and generate corresponding entries in its information store database 130 to implement the information store fields 170a-170n based on the respective requested schema (e.g., including spatial data field schemas 215a-215n and geographical data field schemas 225a-225n) by recording its respective attributes (e.g. name, data type, storage capacity, and display format) and other information store attributes as may exist in the respective information store type schema 200a-200n (e.g. display options, security restrictions, etc.) Finally, entries are made in its information store database 130 to add additional data container(s) or row(s) 240a-240n to the newly created information store (e.g. 128a) based on the requested GIS-enabled information store schema. Note that the process of steps 306-310 is, or can be, iteratively performed by the collaboration tool server 120.

FIG. 4 depicts a flow diagram illustrating a process 400 performed by the collaboration tool server 120 to allow a user to create or update a data container or row (e.g. 240a) in a GIS-enabled information store 128a-128n in accordance with the present invention. Initially, the collaboration tool server receives a request from a requester (e.g., a user operating client computer 50 or a network external application 70) to create or update a data row (e.g. 240a) (Step 402). In one implementation, this request takes the form of the browser 52 posting a web page to the collaboration tool server 120 providing the location and identity for the relevant information store (e.g. 128a) and the identities and values for business information store fields (e.g., 280a-280j) and spatial reference point information store fields (e.g., 280k-280q) associated with the schema (e.g., 230a-230n and 200a-200n) associated with the instant information store (e.g. 128a). For updates to an existing data container or row (e.g., 240a), the identity of such data row is also provided. In an alternate implementation the request takes the form of an XML web service call from an external application 70 to the collaboration tool server 120 providing the equivalent information. One of ordinary skill in the art will appreciate that additional or differing means of accomplishing the logically equivalent outcome may exist based on the various collaboration engines 126 used by the collaboration tool server 120.

Next, the collaboration tool server 120 then locates the requested information store and creates or updates the data container or row (e.g. 240a) as requested (Step 404). In one implementation, the collaboration tool server 120 requests the collaboration engine 126 to locate the schema of the referenced information store (e.g. 128a) from its information store database 130, then, in the case of an update, locate the respective data container or row (e.g., 240a) from the information store (e.g., 128a). In the case of an update, the information store type schema (e.g., 200n) associated with or used by the collaboration tool server 120 to instantiate the respective data container or row is referenced to match the data element names & values provided in the update request with the underlying physical storage of the information store database 130, and to direct the information store database 130 to store such updated values in the matched physical locations for the data row (e.g., 240n). To create a new data container or row (e.g., 240n) the collaboration tool server 120 performs a similar process as an update using the collaboration tool engine 126; the schema 230a-230n and/or 200a-200n associated with the respective information store 128a-128n is referenced to match provided data elements and values provided in the create request with the underlying physical storage of the information store database 130, followed by directing the information store database 130 to create a new data container or row (e.g., 240n) with the new values in the matched physical information store fields 170a-170n of the new data container or row.

The collaboration tool server 120 then determines whether the collaboration tool engine 126 has a event subscription interface 142 (step 406). In one implementation, the collaboration tool server 120 may be preprogrammed to recognize which collaboration tool engine 126 has an event subscription interface 142. Alternatively, the collaboration tool server 120 may be operatively configured to interrogate the collaboration tool engine 126 to determine whether it has an event subscription interface 142. If the collaboration tool engine 126 does not provide a suitable event subscription interface 142, the collaboration tool server 120 next performs steps 410-414 as discussed below. If the collaboration engine does provide a suitable event subscription interface 142, the collaboration tool server 120 next performs steps 420-424 as discussed below. After performing either steps 410-414 or steps 420-424, the collaboration tool server 120 continues processing at step 430.

A “suitable” event subscription interface 142, if present, is a mechanism provided by the collaboration engine 126 as discuss herein whereby a standing request can be registered with the collaboration engine 126 (e.g., via event subscription 270 in the control specification 132) to cause it to reliably communicate, via whatever suitable technical means and in near real time, a message back to the requesting programmatic module whenever the collaboration engine 126, for whatever reason & by whatever method, is caused to perform the creation or update of a data row (e.g. 240a) within some or all of its information stores (e.g., 128a). Such message must contain sufficient information for the requesting module to unambiguously locate such information store and data row. Such standing request, once made, must be retained by the collaboration engine 126 in effect indefinitely, surviving such occurrences as physical machine shutdown/restart, backup, or other problem of the collaboration tool system 102.

After determining that the collaboration tool engine 126 does not have an event subscription interface 142, the event trigger module 140 of the collaboration tool server 120 monitors or receives notice of the instant new/updated data row (e.g. 240a) and its identifying information (step 410). In one implementation, the information store database(s) 130 are modified with one or more triggers, a standard term of art for certain database programming features, such that the trigger(s) will recognize when the collaboration engine 126 has instructed the information store database 130 to create or update a GIS-enabled data row (e.g. 240a) as described in step 404. In the course of a triggers' activation, the event trigger module 140 consults information available in the information store database 130 to determine the identity of the information store (e.g. 128a) and data row (e.g., 240a).

Next, an event trigger module 140 communicates the event occurrence to a response module 141 (step 412). In one implementation, the event trigger module 140 constructs a message (not shown in figures) containing the message type, identity of the trigger, identity of the affected information store (e.g. 128a) and the respective data container and row (e.g., 240a) and the type of change made, e.g. create or update. The event trigger module 140 then causes the assembled message to be placed in a queue of various similar messages which is monitored by the event response module 141. In one implementation, such queue is realized via the Microsoft Messaging Queue subsystem (“MSMQ”) or various other event trigger modules.

Next, the event response module 141 determines whether the event occurrence or the notice of change corresponds to a GIS-enabled data container or row update (e.g., spatial reference point 252 update), and if so, communicates the event occurrence or notice of change to the geo-coding interface 144 (step 414).

After determining that the collaboration tool engine 126 does have an event subscription interface 142, the event subscription interface 142 receives notice of the new/updated data container or row (e.g., 240a) (Step 420) as previously described in reference to event subscription 270. In one implementation, the collaboration engine 126's event subscription interface 142 stores information about event subscriptions 270 in secondary storage 110 and/or memory 108. One ordinarily skilled in the art can readily appreciate that the specificity of event subscriptions may vary between differing collaboration engines 126.

Next, the event subscription interface 142 communicates the event occurrence or the notice of change to the event response module 141 (step 422). In one implementation, when operatively configured, the present invention's event subscription is retrieved by the event subscription interface 142 in response to any data row creation/update event affecting an information store 128a-128n associated with the event subscription 270. The event subscription interface 142 then communicates the event occurrence or notification of change to the event response module 141 by instantiating an copy of such module and passing to it a notification containing the nature of the event and the identity of the information store (e.g. 128a) and data row (e.g. 240a) associated with the event. One ordinarily skilled in the art can readily appreciate additional or differing functionally equivalent possibilities which may exist when the present invention is applied to differing collaboration engines 126.

Next, the event response module 141 determines if the notice of change is a GIS-enabled data container or row update, and if so, communicates the event occurrence or notice of change to the geo-coding interface 144 (step 424), for example, as discussed in step 412.

Next, after performing step 414 or 424, and receiving the identities of the data row (e.g. 240a) and information store (e.g. 128a) associated with the create or update event occurrence, the geo-coding interface 144 retrieves the spatial reference point 252 data for the data row (e.g. 240a) from the information store (e.g. 128a) (Step 430). In one implementation, the geo-coding interface 144 utilizes the standard data access mechanisms of the collaboration engine 126 to obtain the spatial reference point 252 data associated with the schema (e.g., 200n) of the information store (e.g. 128a).

The geo-coding interface 144 then identifies the corresponding source-specific geo-coding connector 146 from the operable configuration and context associated with the respective information store (e.g., 128a), and passes the spatial reference point 252 data to the identified geo-coding connector (Step 432). In one implementation, the geo-coding interface 144 references the information store schema 128a to determine the corresponding spatial data type schema 210 from the control specification 132 and thereby determine the appropriate geo-coding connector 146. In another implementation, the configuration information may be stored internal to the collaboration tool server 120 to identify a geo-coding connector 146 for each instantiated information store 128a-128n.

Next, the geo-coding connector 146 contacts the geo-coding source system 150, provides it the spatial reference data and in turn receives geographical reference data, geo-coding status/results message, plus optional additional geographical attributes (Step 434). The geographical reference data, geo-coding status/results message, plus such additional geographical attributes as are made available are collectively termed herein “geographical results”. In one implementation, the geo-coding connector 146 contacts Microsoft® MapPoint Web Services® via XML web service and passes the spatial reference point information to the XML web service according to its well-known documented syntax and semantics. In response, the Microsoft® MapPoint Web Services® XML web service provides geographical results that include a geographical reference point (i.e. latitude & longitude), and an indication of success or failure and if failure some diagnostic information as to cause of failure.

The geo-coding connector 146 then passes the received geographical results back to the geo-coding interface 144 (Step 436). In one implementation, the geo-coding connector 146 composes such results into its return object (a term of art commonly known to skilled practitioners) and transfers the return object and programmatic control back to the geo-coding interface 144.

Next, the geo-coding interface 144 posts the geographical results back to the collaboration tool server 120 along with a reference to the associated information store (e.g., 128a) and identification of the data container or row (e.g., 240n) (Step 438). In one implementation, the geo-coding interface 144 uses the identity information obtained in step 414 or 424 to identify the instant data row (e.g. 240a).

The collaboration tool server 120 then locates the identified information store 128a and data row and updates the data row as requested (Step 440) before ending processing of process 400. In one implementation, the collaboration tool server 120 requests the collaboration tool engine to update the geographical reference point 254 data of the identified data container or row of the identified information store (e.g., 128a).

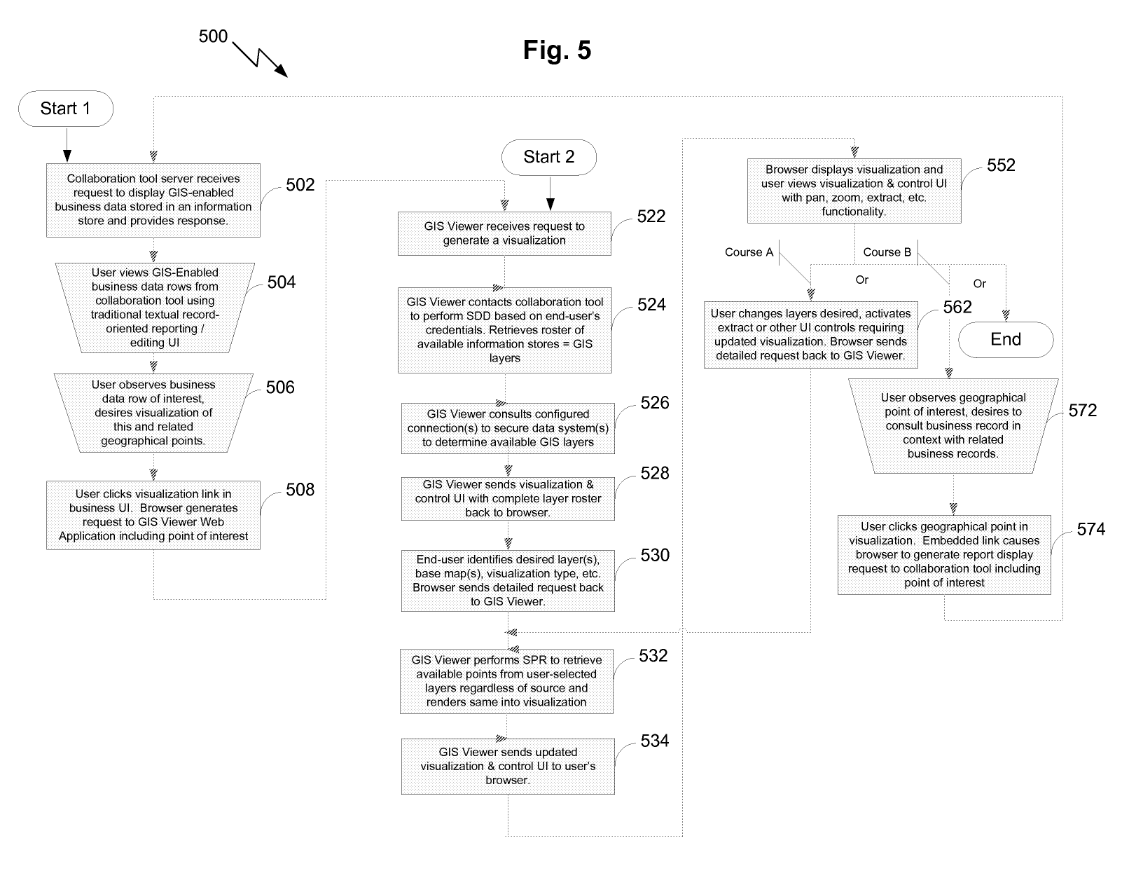

Turning to FIG. 5, a flow diagram is shown illustrating a process 500 performed by the collaboration tool server 120 working cooperatively with the web-based GIS viewer 124 to allow a user to selectively view a visualization of one or more GIS-enabled information stores 128a-128n in accordance with the present invention. Because this is a cooperative effort between two largely independent components of the collaboration tool system 102, there is a respective start point, labeled Start 1 & Start 2 on FIG. 5, associated with the respective component (the collaboration tool server 120 and the web-based GIS viewer 124 for performing the process 500. Although the process 500 is described herein as beginning with Start 1 based on an end-user access of the collaboration tool server 120, an end-user operating on a client computer 50 could alternatively first access the web-based GIS viewer 126 to cause the process 500 to begin at Start 2. To provide clarity to this aspect of the present invention associated with the process 500, a representative example involving an emergency management application dealing with evacuating a nursing home in the face of rising floodwaters is presented in context with the description of the process 500.

Commencing from point Start 1, the collaboration tool server 120 receives a request to display GIS-enabled business data (e.g. 240a) stored in an information store (e.g. 128a) and provides response. (Step 502). As a representative example, consider an information store containing data rows corresponding to nursing homes and containing business data consisting of management contact information and resident census information as well as spatial reference information (i.e. street address) and geographical reference information (i.e. latitude/longitude). In one implementation, the request is in the form of a web page posted from the user's browser 50 which instructs the collaboration tool server 120 to generate a tabular report of data container(s) or row(s) (e.g. 240a-240n) from an information store (e.g. 128a). In response, the collaboration tool server 120 retrieves the requested data from its information store database 130 and generates a web page containing the data formatted in a tabular row and column fashion. Because the information store (e.g. 128a) is GIS-enabled with spatial reference point 252 data and corresponding reference point 254 data as described herein in addition to business data 250, the information store includes a geographical reference URL which corresponds to a command to the web-based GIS viewer 124 to display a visualization of a certain configured type and containing a geographical reference point corresponding to this business record 250. The tabular data on the web page includes the geographical reference URL as a selectable (i.e., navigable) link. Having assembled the web page as described above, the collaboration tool server 120 transmits the page to the user's browser 50 for display.

Next, the user views the GIS-Enabled business data containers or rows 240a-240n from the collaboration tool server 120 using traditional textual record-oriented reporting or editing user interface (not show in figures) (Step 504). As a representative example, assume the user (an emergency management dispatcher) has requested the information associated with GIS-enabled business data containers or rows 240a-240n because of a call from one nursing home reporting rising floodwaters threatening their facility & residents. The user observes via the browser 50 the data 240a-240n as provided by the collaboration tool sever 120 sorted by name & locates the affected home.

Next, the user observes a business data row of interest (e.g., 240n) and requests the collaboration tool server 120 provide a visualization of this business data row of interest in association with related geographical reference points (e.g., point 254) (Step 506). As a representative example, our user recognizes the nursing home by name and wants to view it, and other nearby nursing homes, on a map (not shown in figures) created by the web-based GIS viewer 124 including topographical data and floodwater contour predictions.

Next, the user clicks the visualization link in the business user interface displayed by the collaboration tool server on the user's browser 50. The browser 50 generates a corresponding request to the web-based GIS viewer 124 application including the point of interest identified in step 506 (Step 508). As a representative example, our user clicks a “Map me” link (not shown in the figures) in the tabular data row corresponding to the nursing home of interest. In one implementation, the collaboration tool server 120 had provided that link in step 502, including a reference to the specific network location of the web-based GIS viewer 124 application (i.e. URL for the web-based GIS viewer 124), the standard visualization type for that information store (e.g. 128a) (i.e. 2-D map with topographical data), and the geographical location of the instant data row (i.e. latitude & longitude derived from the address of the nursing home stored in the spatial reference point data 252 associated with the business data row 250). When the user clicks the link, the browser navigates to the given URL triggering the web-based GIS viewer 124.

Next, the web-based GIS viewer 124 receives the request to generate a visualization (Step 522). As a representative example, the web-based GIS viewer 124 receives the request generated by our user in step 508. In one implementation, the web-based GIS viewer 124 examines the request to determine the visualization type desired and the geographical reference point(s) 254 desired. If such parameters are missing from the request, the web-based GIS viewer 124 provides a default visualization (for example, a 2D map) lacking any visible geographical reference points and centered on a operatively configurable geographical location (typically the center of the installation's region of interest or responsibility).

Next, the web-based GIS Viewer 124 contacts the collaboration tool server 120 to perform SDD based on the end-user's credentials (e.g., corresponding to the end-user's profile stored on the data processing system in accordance with known authentication techniques). The web-based GIS viewer retrieves a roster of available information stores or equivalently, GIS layers (Step 524). As a representative example, the web-based GIS viewer contacts the collaboration tool server 120's SDD component which reports that this user has available GIS-Enabled information stores 128 including schools, school bus storage yards, and current up-to-the-minute locations of city transit busses. In one implementation, the communication from the web-based GIS viewer 124 to the collaboration tool server 120 is accomplished via XML web service and passing along the end-user access credentials. The SDD component 192 web service queries the collaboration engine 126 via its well-known documented interfaces to determine the topology of the installation as of that moment and the GIS-enabled information stores available at each point in the topology to that user in accordance with the user's credentials. The collaboration engine 126 consults the secondary storage 110 and information store database(s) 130 to determine the appropriate response(s) to the SDD 192 web service queries. The collaboration tool server 120's SDD component 192 web service returns this information to the web-based GIS viewer's SDD interface 194 as an XML document. One of ordinary skill in the art will appreciate that other interface mechanisms are usable as well.

Next, the web-based GIS viewer 124 consults configured connections to secure data system(s) 160 to determine available GIS layers (Step 526). As a representative example, the web-based GIS viewer 124 contacts a secure data system 160 belonging to the emergency management agency which reports that topographical contours are available, as are real-time flood water depth maps generated from data provided by radio-based sensors located on traffic lights throughout the area. In one implementation, the web-based GIS viewer 124 communicates with ESRI ArcIMS secure data system servers via network 51 using the ArcIMS proprietary communications protocol to authenticate and determine available layers and map overlays. One of ordinary skill in the art can readily appreciate additional or differing functional equivalent communication technique or protocols may be employed based on the particular secure data system 160.

Next, the web-based GIS viewer 124 sends the requested visualization and control user interface with complete layer roster back to the requesting browser 50 (Step 528). As a representative example, the web-based GIS viewer 124 provides the requested 2D map with topographical data centered on and displaying a reference point icon representing the nursing home. The response to the browser also includes a control user interface containing the roster of available collaboration tool server 120-based layers (schools, school bus yards and city busses) and the secure data system 160-based layers (the topographical contour information and the flood water depth information). In one implementation, the layers are depicted as a tree structure of layer names, each with check boxes to enable end-user selection. The visualization tool portion of the web-based GIS viewer 124 is capable of several types of visualization, including without limitation, 2D maps, 3D maps, and aerial photographs selected by dropdown controls. Additional capabilities of the control user interface include without limitation, selecting specific points by click, dragging a lasso around one or more points to select multiple points, zoom, pan, & rotate. In one implementation, the actual visualization is generated (“rendered” being the term of art) by Microsoft® Virtual Earth®, an XML web-service AJAX based technology. One ordinarily skilled in the art can readily appreciate additional or differing functionally similar possibilities which may exist when the present invention is applied to differing visualization rendering systems of similar purpose from other vendors. Upon receipt, the requesting browser 50 displays the visualization and control user interface as provided by the web-based GIS viewer for the user.

Next, the end-user identifies desired layer(s), base map(s), and visualization type to the web-based GIS viewer 124. The end-user's browser 50 sends the identified information in a request back to the web-based GIS viewer (Step 530). As a representative example, the user may decide to see flood water levels and current city bus locations and nursing home locations overlaid together on the map. In one implementation, the user selects the desired map via a dropdown menu, checks the boxes for the desired layers, and clicks the “update map” button (not shown in figures). The browser 50 processes the inputs and generates a corresponding command which is transmitted to the web-based GIS viewer 124 via XML/AJAX technology.

Next, the web-based GIS viewer 124 performs the SPR subprocess to retrieve available points from user-selected layers regardless of source and renders the same into a visualization for display on the user's browser 50 (Step 532). As a representative example, the web-based GIS viewer receives the request generated by the user in step 530 and responds by contacting the collaboration server tool 120 to retrieve the requested layers (nursing homes & city busses) and contacting the secure data system 160 to retrieve the other requested layers (topographical and flood waters). In each case, the user's credentials may also be passed so that the respective secure data systems 160 is able to determine whether and which, data points to expose. In one implementation, the communication from the web-based GIS viewer 124 to the collaboration tool server 120 is accomplished via XML web service to authenticate & retrieve data while the communication to secure data system 160 (i.e. ESRI ArcIMS servers) uses the ArcIMS proprietary communications protocol. Following SPR data retrieval, the web-based GIS viewer 124 adds the requested points, contours or other graphical features (e.g. floodwater coloring based on depth) to the visualization type requested by the user. The geographical reference points 254 are rendered on the visualization using various representative icons and colors. Each geographical reference point 254 is also provided on the visualization with certain business attributes such as name or status. Each geographical reference point 254 is also provided by the web-based GIS viewer 124 on the visualization with a navigable URL to cause the browser 50 to request the collaboration server 120 to provide detailed information on that point and/or a tabular report of related points from the corresponding information store 128.

Next, the web-based GIS viewer 124 sends the updated visualization and control user interface to the user's browser 50 (Step 534). As a representative example, the web-based GIS viewer transmits the result of step 532 back to the browser 50 as discussed above. In one implementation, this is accomplished via standard internet communications protocols, including TCP/IP, HTTP, and SSL.

The browser 50 displays the visualization and the control user interface provided by the web-based GIS viewer 124, allowing the user to pan, zoom, extract, and use other known mapping functionality options (Step 552). As a representative example, the web-based GIS viewer 124 displays the result of step 532 on the user's browser 50. In one implementation, the browser uses a mixture of static HTML, DHTML and AJAX technologies to achieve this result.

After providing the visualization to the browser 50 in step 552, the process 500 can take several courses based on user input via the browser 50. The user is free to end the GIS visualization process 500, perhaps to return their browser 50 to the collaboration tool server 120 to access other unrelated data. This is depicted in FIG. 5. by the Stop oval. The visualization process may take two other courses of action as discussed below.

As shown in FIG. 5, the user (via the visualization and control user interface provided by the web-based GIS viewer 124) may change or select other layers for visualization, activate point extract or other options of the control user interface requiring an updated visualization. The browser sends detailed request back to GIS Viewer 124 (step 562). As a representative example, the user decides to add the school bus yard layer to the display and change the visualization type to aerial photograph. In one implementation, the user selects the desired map via a dropdown of the control user interface provided by the Web viewer 124, checks the boxes for the desired layers, and clicks the “update map” button. The browser processes the inputs and generates a corresponding command which is transmitted to the web-based GIS viewer 124 via XML/AJAX technology. After performing step 562, processing continues at step 532, for example, to iterate several times through steps 532, 534, 552, and 562 in turn as the user adjusts the information displayed to accomplish their business purpose.

Alternatively, after providing the visualization to the browser 50 in step 552, the user may observe a geographical point of interest and desire to consult via the collaboration tool server 120 the corresponding business record in context with other related business records. (Step 572). Continuing with the representative example, the user observes that a city bus number “314” is near the affected nursing home and could be diverted to pick up the residents while still avoiding the nearby floodwaters. To contact the bus, the user needs the driver's cell phone number which is stored with the city bus data in an information store (e.g., 128b) managed or hosted by the collaboration tool server 120.

The user clicks on a geographical point having an embedded link in the visualization currently displayed on the user's browser by the web-based GIS viewer 124. The embedded link causes the user's browser 50 to generate a report display request that includes the point of interest to the collaboration tool server 120 (Step 574). As a representative example, the user may click on an icon representing city bus 314 that is displayed in association with the GIS-enabled visualization provided by the web-based viewer 124 and currently in view on the user's browser 50. The browser 50 navigates based on the embedded link to a page provided by the collaboration tool server 120 which displays detailed information about bus 314 including the driver's cell phone number. Thus the present invention enables the user to readily contact the bus and divert it to pick up the threatened nursing home residents before the flood waters arrive. In one implementation, the SPR retrieval process includes querying the collaboration tool server 120 to determine the appropriate URL to request a data-row detail display of the corresponding data row 240 from the corresponding information store 128. This URL is carried through the request/response chain from steps 532, 534, 552, 572, to 574.

In response to performing step 574, processing continues at step 502 where operation reverts back to the collaboration tool server 120. As will be apparent to a discerning reader, the same cycle can be started at point Start 2 of FIG. 5 and carried around and back to Start 2.

Each of the components 120, 122, and 124 of the collaboration tool system 102 may be installed in the same physical computer system or on separate co-located or geographically-dispersed computer systems for redundancy, survivability, and/or load sharing. Additional secure computer systems 60 (one or many) may be co-located, or geographically dispersed with connections provided by any relevant secure connection technology. Auxiliary business data sources 122 (one or many) may also be co-located, dispersed, or both, and connected with any relevant technology. External Applications 70 (one or many) may also be co-located, dispersed, or both, and connected with any relevant technology.

The collaboration tool server 120, the geo-coding driver 122, and the web-based GIS viewer 124 each may comprise or may be included in one or more code sections containing instructions for performing respective operations as discussed herein, which may be accessed and run by the CPU 104. Although the collaboration tool server 120, the geo-coding driver 122, and the web-based GIS viewer 124 and other programs are described as being implemented as software, the present invention may be implemented as a combination of hardware and software or hardware alone (such as in a ASIC device). Also, one of skill in the art will appreciate programs may comprise or may be included in a data processing device, which may be a separate server, communicating with the collaboration tool system 102 via the network 51.

In addition, although aspects of one implementation shown in FIG. 1A are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing system 100 have been described, a data processing system suitable for use with methods, systems, and articles of manufacture consistent with the present invention may contain additional or different components.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method in a data processing system for extending the business data associated with a network-based user collaboration tool engine to include spatial reference information for collaborative visualization, the collaboration tool engine having one or more business data type schemas for generating an information store container associated with a respective business data element, the method comprising:
providing a control specification to the collaboration tool engine, the control specification having one or more information store type schemas, each information store type schema identifying a corresponding spatial data type schema in association with a geographical data type schema;
receiving a request to generate a new information store;
generating, via the collaboration tool engine, the new information store based on the one or more business type schemas;
providing to the requester a roster identifying the one or more information store type schemas;
receiving a second request to add the one or more information store type schemas to the new information store;
in response to the second request, generating, via the collaboration tool engine, a spatial reference point container in the new information store for each of the one or more information store type schemas based on the spatial data type schema identified by the respective information store type schema.

2. A method of claim 1, wherein each information store type schema identifies the corresponding spatial data type schema in association with a geographical data type schema.

3. A method of claim 2, further comprising, in response to the second request, generating, via the collaboration tool engine, a geographical reference point container in the new information store for each of the one or more information store type schemas based on the geographical data type schema identified by the respective information store type schema.

4. A method of claim 3, further comprising:
monitoring the collaboration tool engine to identify when one of the spatial reference point containers has been updated; and
when the one spatial reference point container has been updated, obtaining a new geographical reference point from a geo-coding source system based on the updated one spatial reference point and storing the new geographical reference point in the geographical reference point container associated with the one spatial reference point container.

5. A method of claim 3, wherein the collaboration tool engine has an event subscription interface, the method further comprising:
assigning an event within the event subscription interface to an event trigger module associated with the new information store, wherein the event identifies when the collaboration tool engine has updated one of the spatial point containers of the new information store and an occurrence of the event is communicated to the event trigger module;
when an occurrence of the event is communicated to the event trigger module, obtaining a new geographical reference point from a geo-coding source system based on the updated one spatial reference point and storing the new geographical reference point in the geographical reference point container associated with the one spatial reference point container.

6. A method in a data processing system for extending the business data associated with a network-based user collaboration tool engine to include spatial reference information for collaborative visualization, the collaboration tool engine having one or more business data type schema for generating an information store container associated with a respective business data element, the method comprising:
providing a control specification to the collaboration tool engine, the control specification having one or more information store type schemas, each information store type schema including a spatial data type schema;
determining whether the collaboration tool engine has generated or exposed a business data information store record or document having a spatial reference point in accordance with the control specification;
when it is determined that the collaboration tool has generated or exposed a business data information store record or document having a spatial reference point in accordance with the control specification,
generating a geographical reference point corresponding to the spatial reference point; and
storing the geographical reference point with the spatial reference point.

7. A method of claim 6, further comprising
receiving a user request to view the business data information store record or document; and
in response to the user request, displaying a map or other visualization to reflect the geographical reference point.

8. A method of claim 7, wherein the collaboration tool engine has a plurality of business data type schemas, the method further comprising:
prompting the collaboration tool engine to generate the business data information store based on at least one of the business data type schemas and the one or more information store type schemas.

9. A method of claim 7, wherein the collaboration tool engine has a plurality of business data type schemas, further comprising:
displaying a roster identifying each of the business data type schemas and the information store type schemas;
receiving a request identifying one of the business data type schemas and one of the information store type schemas; and
prompting the collaboration tool engine to generate the business data information store to have a first container based on the one business data type schema identified in the request and a second container based on the spatial data type schema of the one information store type schema identified in the request.

10. A data processing system, comprising:
a collaboration tool system including a secondary storage having a control specification having one or more information store type schemas, each information store type schema identifying a corresponding spatial data type schema in association with a geographical data type schema;
the collaboration tool system further including a memory having a collaboration tool server and a geo-code driver operatively connected to the collaboration tool server and operatively configured to communicate with a geo-coding source, the collaboration tool server being operatively configured to control a collaboration tool engine based on the control specification, receive a request to generate a new information store, generate the new information store based on the one or more business type schemas via the collaboration tool engine, provide to the requestor a roster identifying the one or more information store type schemas, receive a second request to add the one or more information store type schemas to the new information store, and, in response to the second request, generate a spatial reference point container in the new information store for each of the one or more information store type schemas based on the spatial data type schema identified by the respective information store type schema;
the collaboration tool system further including a processor to run the collaboration tool server and the geo-code driver.

11. A data processing system of claim 10, wherein each information store type schema identifies the corresponding spatial data type schema in association with a geographical data type schema.

12. A data processing system of claim 11, wherein the collaboration tool server is further operatively configured to, in response to the second request, generate a geographical reference point container in the new information store for each of the one or more information store type schemas based on the geographical data type schema identified by the respective information store type schema.

13. A data processing system of claim 12, wherein the geo-code driver is operatively configured to monitor the collaboration tool engine to identify when one of the spatial reference point containers has been updated; and when the one spatial reference point container has been updated, obtain a new geographical reference point from a geo-coding source system based on the updated one spatial reference point and storing the new geographical reference point in the geographical reference point container associated with the one spatial reference point container.

14. A data processing system of claim 12, wherein the collaboration tool engine has an event subscription interface and the collaboration tool server has an event trigger module associated with the new information store and assigned an event within the event subscription interface, the event identifying when the collaboration tool engine has updated one of the spatial point containers of the new information store, the event trigger module being operatively configured to receive an occurrence of the event from the event subscription interface and, in response to receiving an occurrence of the event, to obtain a new geographical reference point from the geo-coding source system based on the updated one spatial reference point and storing the new geographical reference point in the geographical reference point container associated with the one spatial reference point container.
